(19) United States
(12) Patent Application Publication
(10) Pub. No.: US 2016/0078527 A1
(43) Pub. Date: Mar. 17, 2016

(54) Device and method for conducting financial services business via remote video conference

(71) Applicants: Richard B. Dupuis, Topsham, ME (US); Michael J. Foley, Cape Elizabeth, ME (US)

(72) Inventors: Richard B. Dupuis, Topsham, ME (US); Michael J. Foley, Cape Elizabeth, ME (US)

(21) Appl. No.: 14/157,990

(22) Filed: Jan. 17, 2014

(51) Int. Cl. G06Q 40/02; G06Q 20/10

(52) U.S. Cl. CPC G06Q 40/02; G06Q 20/1085

(57) ABSTRACT

A device and method for integrating the functions of ATMs, online banking, and other financial services into a single user-friendly video conferencing station at which a customer and representative of a financial institution may converse face to face in real time and conduct any and all of the business they would otherwise be able to conduct in person in an office on the premises of the financial institution. The station consists of: a unit roughly the size and shape of a standard office desk and containing a monitor for videoconferencing, a scanner and printer for exchanging documents, a smaller scanner for verification of identification cards, and an electronic signature pad; and an ATM or similar kiosk capable of remote operation for dispensing cash and teller checks.

### CROSS REFERENCE TO RELATED INVENTIONS

Not applicable

### COPYRIGHT NOTIFICATION

A portion of the disclosure of this patent document and its figures contain material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

Financial institutions have made use of ATMs for decades, allowing their customers to make cash withdrawals and deposits without the necessity of visiting a branch location. In recent years, ATMs as we know them have evolved to be able to serve more functions than simply “deposit,” “withdrawal,” and “balance inquiry.” Devices that resemble ATMs in appearance now exist that allow customers to, among other things, perform funds transfers from one institution to another, and to print teller checks. As such, consumers are now well accustomed to conducting transactions using such devices, but are still unable to utilize them to conduct that part of their financial business that requires a conversation, or an exchange of documents.

Parallel to the evolution of ATMs, financial institutions have embraced all forms of electronic banking. Customers may check their balances, transfer funds, and pay bills over the internet. Even those financial services which require the most human interaction and exchange, such as account opening and the application for and negotiation of loans, are now offered online.

Meanwhile, real time video conferencing has evolved from science fiction into reality. Any person with an internet connection and the proper computer hardware and software may use Skype and similar services to video conference as easily as they would conference by telephone a generation ago. The hardware and software are now readily available and relatively affordable to consumers in the developed world. As such, consumers are now prepared and may even expect to conduct business via video conference. Financial institutions have taken note, and a few innovative banks and credit unions have set up video conferencing stations in their branches to allow their customers to communicate face to face in real time with employees in other offices, for example, loan processors handling their applications. This provides a face-to-face experience for customers.

Even so, the process has not yet been fully automated. If a customer's requests require physical presentation of ID, such as opening an account, it is difficult to do so remotely from a video conferencing station. If the customer and the financial institution need to exchange documents, such exchange can certainly be done by scanner, and signatures can be processed on electronic signature pads, but this process requires the financial institution to provide the customer with a vast array of computer peripherals and equipment. This can become physically cumbersome, not to mention expensive, and the security risk of leaving computer equipment unattended makes it unfeasible for financial institutions to offer remote videoconferencing from an unstaffed facility without incurring further expenses in security. Even if the financial institution is willing to go to that expense, the customer often still requires assistance from a human on the premises for some aspect of his business, especially if it is necessary to dispense cash or print a check or even a receipt.

Additionally, despite customers' growing familiarity with electronic communication, many still prefer a face-to-face conversation when discussing certain aspects of financial services, hence the recent move into videoconferencing. When customers are seeking any product or service a financial institution offers which lends itself to a dialogue, they are often most comfortable when they can ask questions to the person sitting across from them. These customers often resist the “faceless” nature of conducting business online or even by phone.

As a result of the above factors, financial institutions have had difficulty moving forward from their 20^{th} century business model of heavily staffed brick-and-mortar branch offices, with all the attendant costs and expenses.

### SUMMARY OF THE INVENTION

The invention is intended to solve the problems referred to in the previous section by allowing consumers of financial and banking services to conduct the full range of their business via videoconference from a fully integrated workstation. It is a single unit of roughly the size and shape of a standard office desk, constructed from a single plastic mold. It contains a monitor, microphone, and speakers for video conferencing, as well as all the necessary printing and scanning hardware to allow the user to exchange documents with an employee of his financial institution in real time. It contains an ID scanner to allow the employee to properly identify the customer, and an electronic signature pad allowing the customer to sign any documents as necessary. The mold is designed to allow the components to be anchored inside it so that their interactive surfaces face the consumer at the most comfortable and convenient way; for example, the monitor at face level, and the signature pad, scanners, and printer near to where the customer's hands rest upon the desk surface. The mold further contains the necessary computer hardware and software to run its various components and to connect with a financial institution employee at a remote location, and to allow that employee to control the functions of the unit.

The invention also relies on the presence of an ATM or similar kiosk that is capable of dispensing cash and printing teller checks in close proximity to the unit. This kiosk is capable of receiving remote commands from the financial institution employee who is videoconferencing with the customer. As such, if the customer requires either cash or a teller check, it is dispensed at the kiosk. As such, the invention further consists of this method of conducting transactions by combining the videoconferencing terminal with the kiosk.

The invention allows a financial institution to offer its customers the full range of deposit and lending services remotely that they would otherwise only be able to obtain by going to a traditional fully staffed branch office. When a customer activates the unit by touching the monitor, he is connected by videoconference to an employee of his financial institution in a remote location. The employee may then serve the customer, face to face in real time, just as if they were facing each other across a desk in a traditional branch office. By incorporating the various components into the unit, the financial institution allows the customer to sign (if necessary) and transmit documents, while eliminating the need to provide multiple computer equipment and peripherals. If the financial institution must provide documents to the customer, they are printed out into his hands. The kiosk allows for the dispensation of cash and teller checks. As such, the invention combines the portability and convenience of an ATM with the full-service nature of a branch office, and, unlike online banking, provides a face to face experience for the customer.

### DESCRIPTION OF THE DRAWINGS

FIG. 1: Document Scanner
FIG. 1 depicts the document scanner which is built into the unit, with arrows showing the direction of the paper feed. The scanner itself is mounted within the plastic mold so that, from the user's perspective, it appears on the left-hand side, above the desk surface, facing the user. Documents are fed in a downward direction, through a slot in the convex protrusion from the unit, and removed from the concave section directly below the convex section. FIG. 1 also shows the out-feed from the scanner, as it appears to the user seated in front of it.

FIG. 1A: Document Scanner Cross Section
FIG. 1A depicts a cross section of the plastic mold where the document scanner depicted in FIG. 1 is mounted. The upward pointing section of mold appears as the convex protrusion in FIG. 1, and contains the in-feed for documents. The downward pointing section of mold contains the concave opening and document out-feed.

FIG. 2: ID Scanner
FIG. 2 depicts the scanner for identification cards, such as drivers' licenses. It is mounted within the plastic mold, below the surface level of the desk, on the user's left, with the scanner surface oriented upward and nearly level with but slightly below and parallel to the surface of the desk, protected by and overhanging section of the mold which rises above the surface of the desk. Identification cards are slid into a sleeve between the overhanging molding and the scanner surface, and then slid back out the same way.

FIG. 3: Monitor Front View
FIG. 3 depicts the monitor as it appears to the user facing it. It is mounted within the plastic mold, perpendicular to the surface of the desk, so that it is at the level of the seated user's face.

FIG. 3A: Monitor Cross Section
FIG. 3A depicts the monitor depicted in FIG. 3 as it appears in cross section, mounted within the plastic mold. It is mounted so that only the visual and touch interface screen is visible to the user.

FIG. 4: Signature Pad
FIG. 4 depicts the electronic signature pad as it appears to the user and as it appears in front view within the plastic mold. It is mounted within the mold, below the surface level of the desk, on the user's right, with the surface of the pad on which the user signs nearly level with but slightly below and parallel to the surface of the desk. Users sign on the pad using a plastic stylus, which is affixed to the desk by a short cord which is anchored directly adjacent to the pad.

FIG. 4A: Signature Pad Cross Section
FIG. 4A depicts the electronic signature pad depicted in FIG. 4 as it appears in cross section from the side. In order for the signature pad to be mounted within the plastic mold so that the surface of the pad is parallel to the surface of the desk as in FIG. 4, the housing of the pad must be mounted at an angle, as depicted.

### DETAILED DESCRIPTION

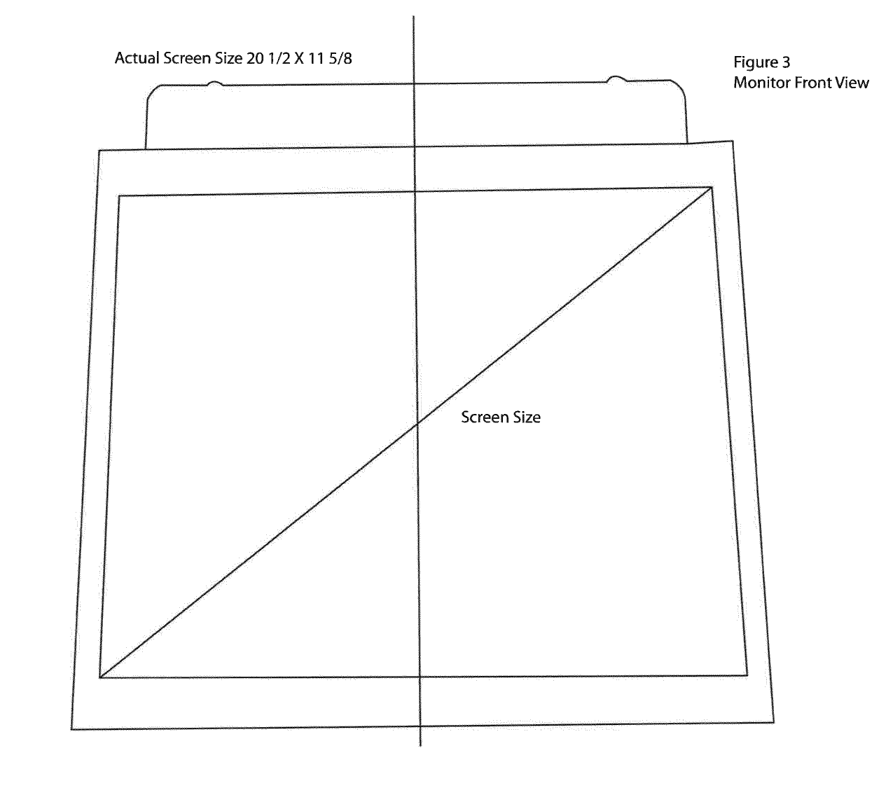

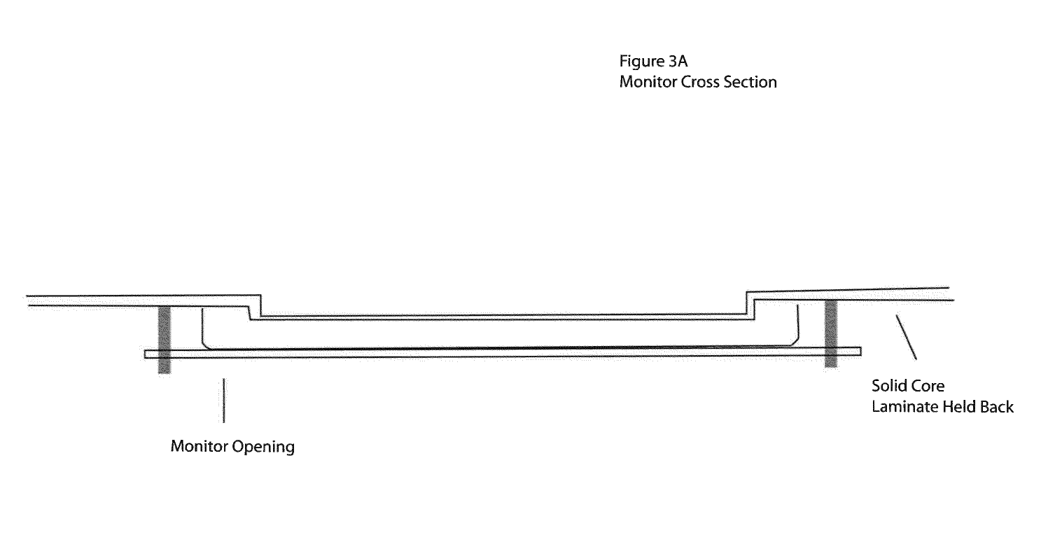

The best mode of carrying out the invention is as follows. The plastic mold must be formed of any composite plastic capable of withstanding the heat generated by a standard computer processor, and of sufficient structural integrity to hold the weight of the monitor depicted in FIG. 3, either by means of anchors in the plastic or by molding the plastic into the shape of anchors. The mold is constructed from a master mold built in roughly the size and shape of a standard office desk; in fact, a desk may be used in the creation of the master mold if it seems practicable to the maker.

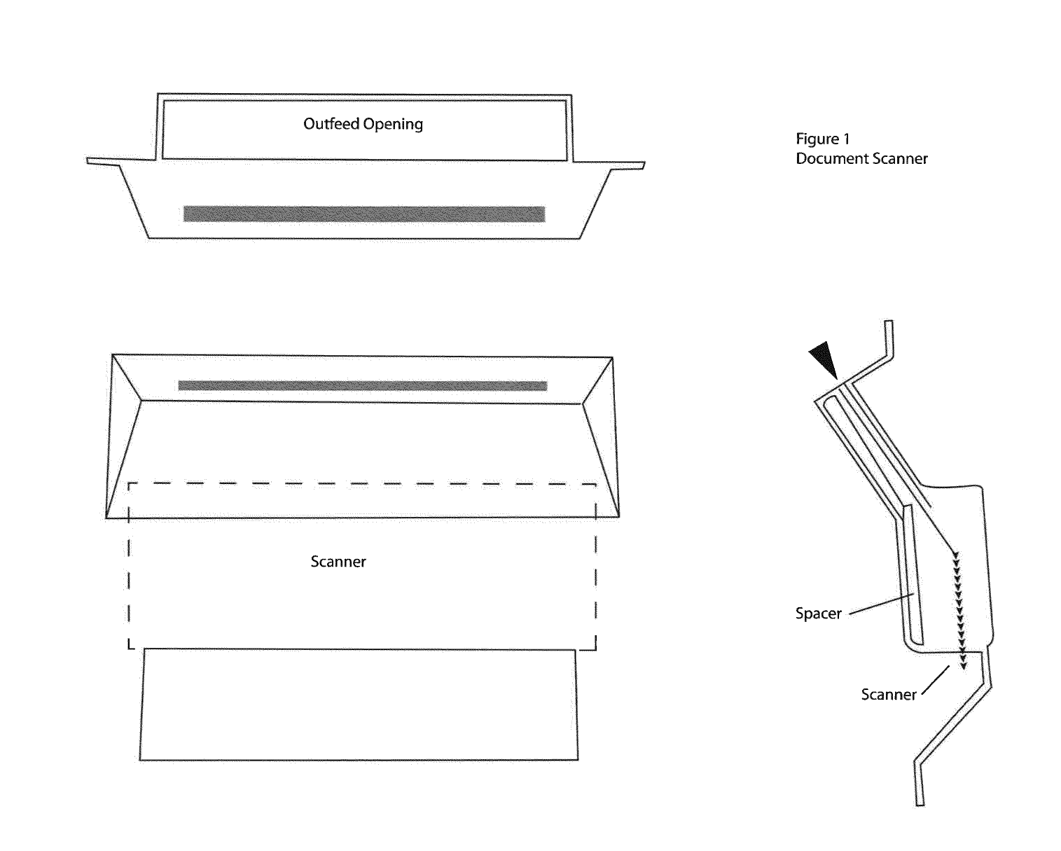

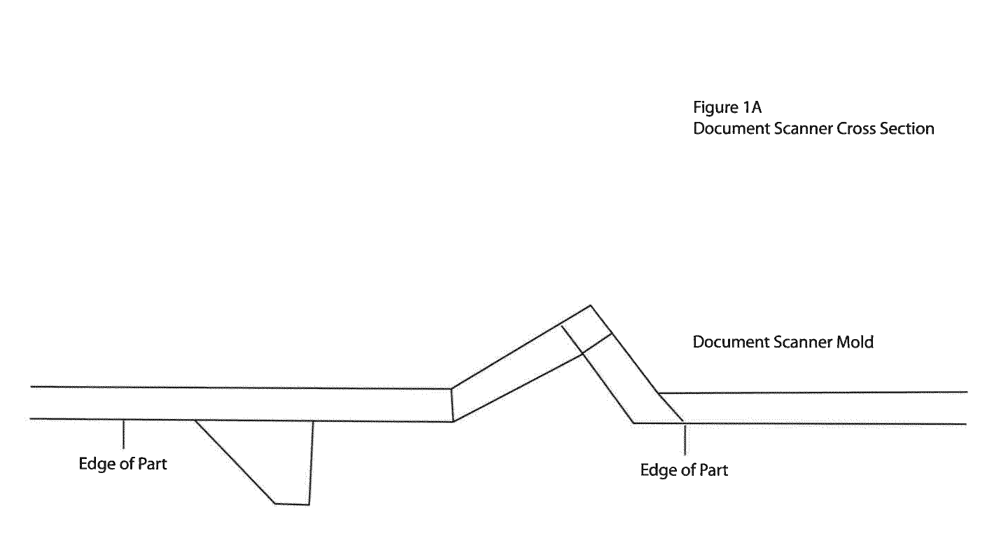

The mounting for the document scanner depicted in FIG. 1 may be constructed by incorporating a piece of metal in the shape depicted in FIG. 1A into the master mold. The document scanner is mounted on the right-angle section that juts into the mold, with the out feed for paper facing directly down in the direction of the desk surface.

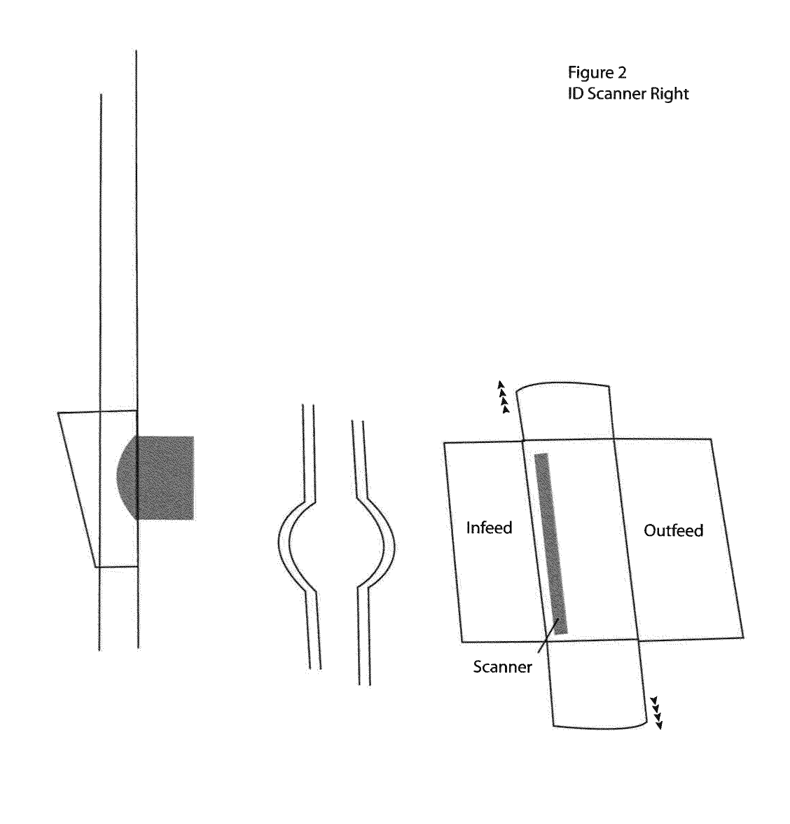

The ID scanner depicted in FIG. 2 is mounted within the unit by anchoring it below the desk surface so that the scanner surface faces upward and is parallel to but slightly below the surface of the desk. A small section of molding should be constructed above it for protection, with a slot for the user to slide his identification card through. The above section of molding may be constructed by incorporating a small cylindrical or trapezoidal bump into the master mold so that it juts upward from the surface of the desk.

The monitor depicted in FIG. 3 must be mounted within the mold and anchored in place at the users face level. This may be done either by molding the plastic in such a way that the monitor may sit within the mold itself, or by affixing anchors into the plastic, or both.

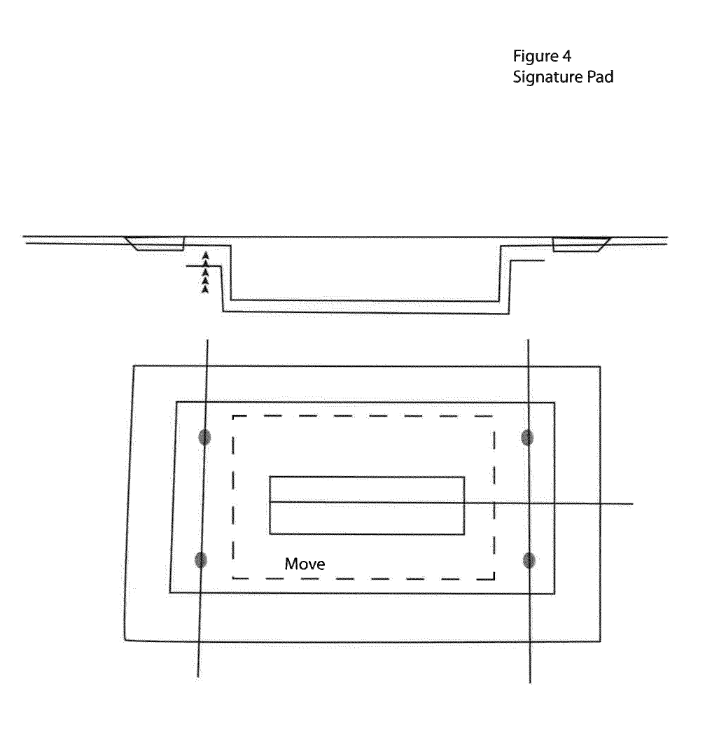

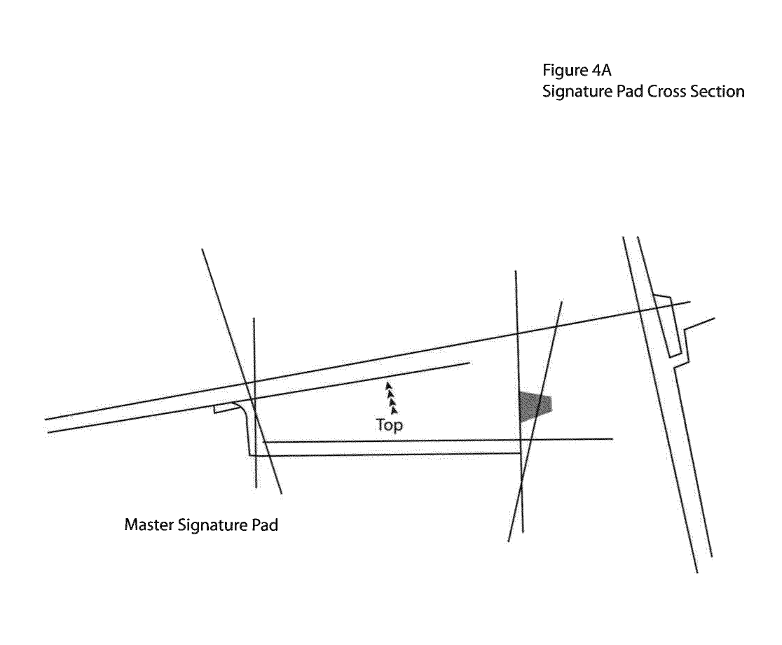

The signature pad depicted in FIG. 4 is mounted within the unit by anchoring it below the desk surface so that the pad surface on which the user signs faces upward and is parallel to but slightly below the surface of the desk.

The mold must also contain the necessary computer hardware and software to power the components and enable them to connect the user with an employee of the user's financial institution in a remote location. These components are located in the lower left section of the mold, below the surface of the desk, but may be located anywhere within the mold that is convenient for the maker to reach for maintenance, if necessary.

The mold may be affixed to the wall or structure of the building in which it is located, but is designed to be portable.

The invention requires the close proximity of an ATM or similar kiosk that is capable of dispensing cash and printing teller checks, and also capable of being remotely controlled to perform such functions by the financial institution employee with whom the user is videoconferencing.

What is claimed is:

1. A device for conducting any and all of the business of financial services, including but not limited to: deposits and withdrawals, funds transfers, account opening, adding, changing, and/or terminating account products and services, loan applications and closings, and receiving general information and assistance, via remote video conference from a fully automated self-service terminal, comprising: a mold of roughly the size and shape of a standard office desk, which contains the remaining components, a touch-interface monitor screen located at face level for the seated operator, a microphone and audio speakers located at face level for the seated operator, an electronic signature pad, a document printer, a document scanner, a smaller scanner specifically for the scanning of photographic identification cards including but not limited to drivers' licenses (the “ID seamier”); allowing the operator to enter commands by touch on the monitor screen and thereby connect with a representative of the operator's financial institution and enter a real-time video conference; allowing the operator to enter identification by the ID scanner; allowing the operator to send documents to the representative of the operator's financial institution by means of the larger scanner; and allowing the operator to receive documents by means of the document printer.

2. The device of claim 1, wherein the mold may be either portable or affixed to the structure of its room or enclosure.

3. The device of claim 1, wherein the mold further comprises the necessary computer software to connect the operator via real time video conference to a representative of the operator's financial institution.

4. The device of claim 1, wherein the mold further comprises the necessary computer software to electronically transmit documents for scanning and printing.

5. The device of claim 1, wherein the mold further comprises the necessary computer software to capture the image from the signature pad and electronically transmit said image.

6. The device of claim 1, wherein the mold further comprises the necessary computer software to capture the image from the ID scanner and electronically transmit said image.

7. A method of conducting any all of the business of financial services, including but not limited to: deposits and withdrawals, funds transfers, account opening, adding, changing, and/or terminating account products and services, loan applications and closings, and receiving general information and assistance, via remote video conference from a fully automated self-service terminal, comprising: the customer connecting to a representative of the customer's financial institution via real time video conference, the representative requesting and the customer sending any identification and/or documentation necessary for the representative to serve the customer's requests, the representative presenting any documents requiring a signature to customer by displaying images of them electronically on the customer's monitor, the customer signing said documents electronically via signature pad, and the representative dispensing any funds requested by cash or teller check from an ATM or similar device located, in immediate proximity to the self-service terminal.

8. The method of claim 7, Wherein the self-service terminal is the device of claim 1.

9. The method of claim 7, wherein the customer interacts with the representative as though both parties were meeting in person in an office of the customer's financial institution.

10. The method of claim 7, wherein the customer's financial institution has placed the device of claim 1 in immediate proximity to an ATM, kiosk, or similar device capable of dispensing cash and printing teller checks.

11. The method of claim 10, wherein the representative is able to remotely operate the ATM, kiosk, or similar device as necessary to dispense cash and/or print teller checks.
